(19) United States
(12) Patent Application Publication
(10) Pub. No.: US 2006/0037368 A1
(43) Pub. Date: Feb. 23, 2006

(54) Anti-slip casing for locks

(76) Inventor: Chun Te Yu, Fusing Township (TW)

Correspondence Address: MORTON J. ROSENBERG,ESQ.;ROSENBERG,KLEIN & LEE, 3458 ELLICOTT CENTER DRIVE, SUITE 101, ELLICOTT CITY, MD, 21043, US

(21) Appl. No.: 10/919,248

(22) Filed: Aug. 17, 2004

(51) Int. Cl. E05B 67/02

(52) U.S. Cl. 70/52

(57) ABSTRACT

An anti-slip lock includes an anti-slip casing connected to the lock body and a plurality of connection portions are defined in the lock body. The anti-slip casing includes anti-slip material which sandwiches a plate which has a plurality of connection members which are engaged with the connection portions.

### FIELD OF THE INVENTION

The present invention relates to an anti-slip casing engaged to a lock.

### BACKGROUND OF THE INVENTION

A conventional lock is made of metal material and the outer surface of the lock generally is polished and smooth so that it is slippery especially when the users' hands are attached with grease. Some manufacturers develop an anti-slip lock which includes apertures defined in an outer case of the lock and the locks are merged in thermoplastic material which is filled in the apertures to form an anti-slip outer surface. Nevertheless, the thermoplastic material often partially fills in the apertures and once the lock is enclosed by the thermoplastic material, the lock cannot be disengaged to maintain the parts in the lock. In other words, the whole lock has to be discarded and cannot be reused or recycled because of the thermoplastic layer.

The present invention intends to provide an anti-slip casing for locks wherein the casing is snapped onto the lock and can be disengaged from the locks when the locks need to be maintained or recycled.

### SUMMARY OF THE INVENTION

The present invention relates to an anti-slip lock that comprises a lock body with a shackle connected thereto and a plurality of connection portions are defined in the lock body. An anti-slip casing has anti-slip material attached thereto and has a plurality of connection members which are engaged with the connection portions to match the anti-slip casing to the lock body.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the anti-slip lock of the present invention;

FIG. 2 is a perspective view to show the anti-slip lock of the present invention;

FIG. 3 shows the tongue in each aperture in the lock body;

FIG. 4 is a perspective view to show the plate sandwiched by the anti-slip material;

FIG. 5 is a cross sectional view to show that the anti-slip casing is to be engaged with the lock body;

FIG. 6 is a cross sectional view to show the anti-slip casing is engaged with the lock body, and

FIG. 7 shows the tongue in each aperture and the tongue is engaged with the hole in each insertion.

### DETAILED DESCRIPTION OF THE PREFERRED EMBODIMENT

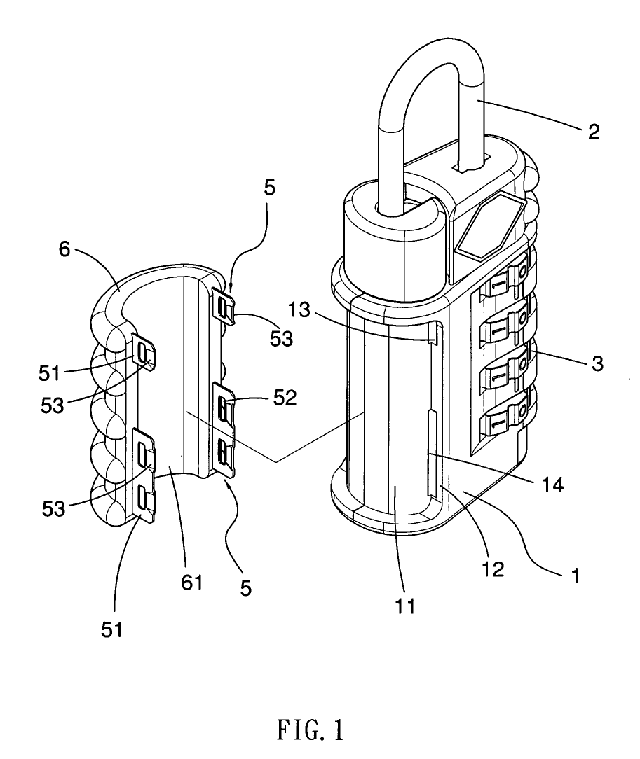

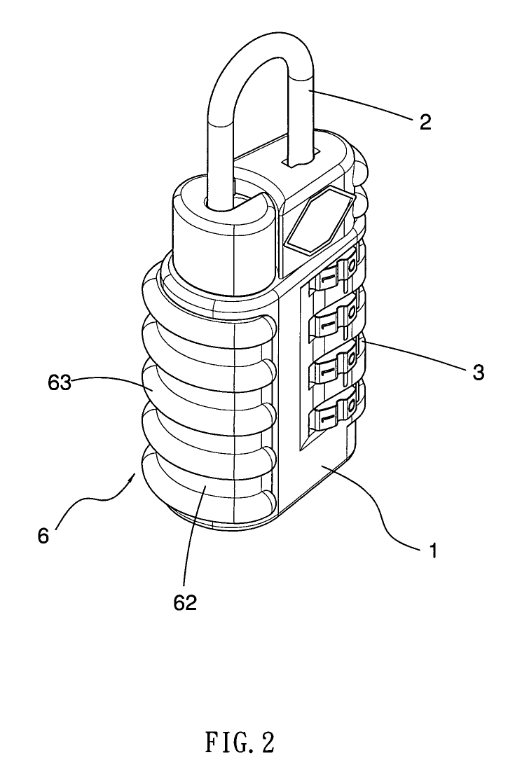

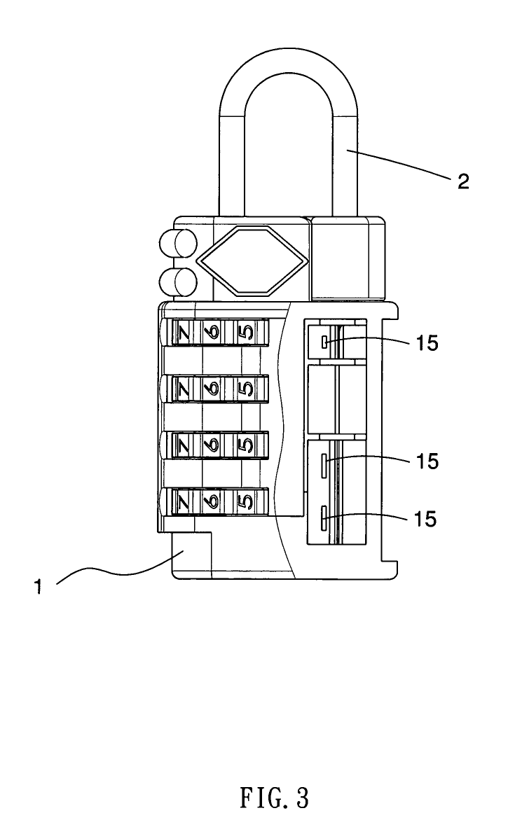

Referring to FIGS. 1 to 3, the anti-slip lock of the present invention comprises a lock body 1 which includes a lock mechanism 3 such as code rings in this embodiment and a shackle 2 is connected to a top of the lock body 1. A recessed area 11 is defined in an outer surface of the lock body 1 and a plurality of connection portions 13, 14 are defined in the two surfaces 12 connected to two sides of the recessed area 11 of the lock body 1. The connection portions 13, 14 are apertures in this embodiment and each of the apertures includes a tongue 15 extending from an inside thereof.

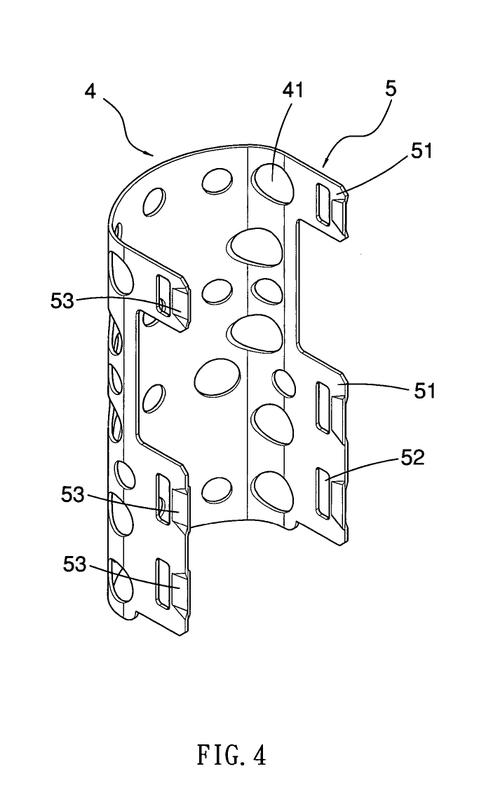

Further referring to FIG. 4, a U-shaped anti-slip casing 6 includes a plate 4 which is made of stiff material such as a metal plate and a plurality of apertures 41 are defined through the plate 4. A plurality of connection members 5 extend from two sides of the plate 4 and each connection member 51 is an insertion 51 which has a hole 52 defined therethrough. Each of the insertions 51 includes a tapered guide groove 53 defined therein. Anti-slip material such as rubber encloses inner and outer sides of the plate 4 to form an inner periphery 61 and an outer periphery 62 from which ridges 63 extend. The apertures 41 allow the rubber to firmly sandwich the plate 4 therein.

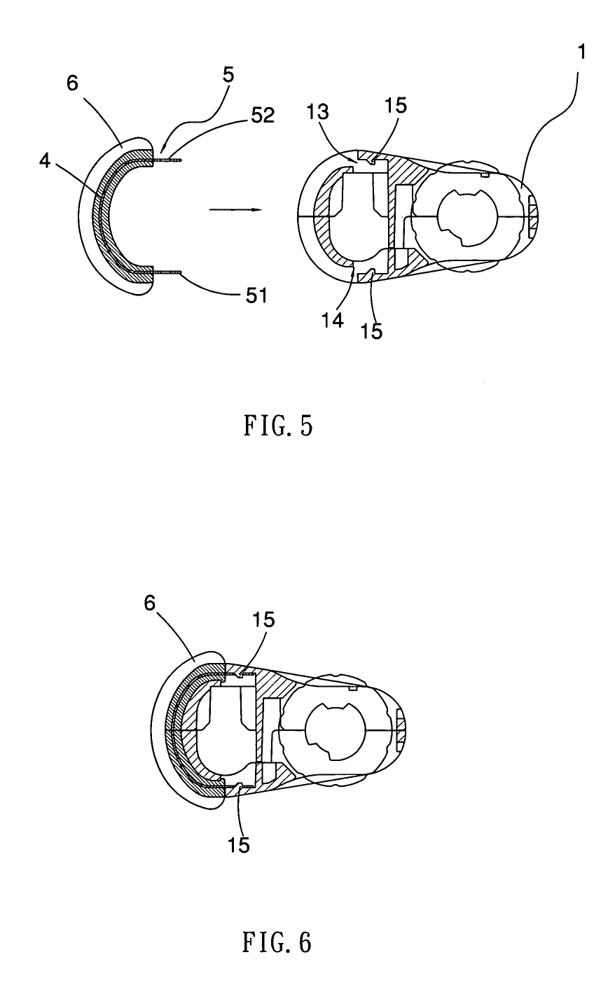

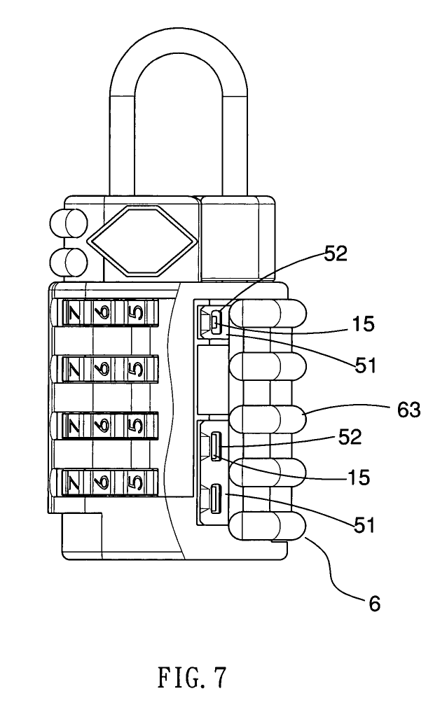

Referring to FIGS. 5 to 7, the anti-slip casing 6 is engaged with the recessed area 11 and the connection members 5/insertions 51 are engaged with the connection portions 13, 14. The tongues 15 move along the guide groove 53 and are engaged with the holes 52 in each insertion 51.

The two sides of the U-shaped anti-slip casing 6 are squeezed inward to assist the connection members 5/insertions 51 to be engaged with the connection portions 13, 14, and the two sides of the U-shaped anti-slip casing 6 then rebound to securely engage the tongues 15 with the holes 52. Besides, the two inner edges of the anti-slip material of the anti-slip casing 6 are squeezed in the connection portions 13, 14 to further position the anti-slip casing 6. The thickness of the ridges 63 project beyond the outer surface of the lock body 1 so as to provide friction when the lock is held by users' hands.

The anti-slip casing 6 is made independent from the lock body 1 and can be disengaged from the lock body 1 so that all the parts of the lock body 1 can be recycled or reused.

While we have shown and described the embodiment in accordance with the present invention, it should be clear to those skilled in the art that further embodiments may be made without departing from the scope of the present invention.

1. An anti-slip lock comprising:
a lock body with a shackle connected thereto, a recessed area defined in an outer surface of the lock body, and a plurality of connection portions defined in the recessed area of the lock body, and
an anti-slip casing engaged with the recessed area of the lock body, and having anti-slip material attached thereto, wherein the anti-slip casing includes a plate enclosed by the anti-slip material and the plate having a plurality of connection members which are engaged with the connection portions of the recessed area.

2. The lock as claimed in claim 1, wherein the connection portions are apertures and the connection members are insertions extending from the plate of the anti-slip casing, the insertions engaged with the apertures.

3. The lock as claimed in claim 2, wherein each of the apertures includes a tongue extending from an inside thereof and each of the insertions has a hole with which the tongue is engaged.

4. The lock as claimed in claim 3, wherein each of the insertions includes a tapered guide groove defined therein such that the tongue moves along the guide groove and is engaged with the hole.

5. The lock as claimed in claim 1, wherein the anti-slip casing includes ridges extending from an outer periphery thereof.

6. (canceled)

7. The lock as claimed in claim 1, wherein the plate of the anti-slip casing has a plurality of apertures defined therethrough.
